(19) United States
(12) Patent Application Publication
(10) Pub. No.: US 2023/0167755 A1
(43) Pub. Date: Jun. 1, 2023

(54) ENGINE VALVE AND MANUFACTURING METHOD THEREFOR

(71) Applicant: FUJI OOZX Inc., Kikugawa-shi, Shizuoka (JP)

(72) Inventors: Takahiro TSUCHIYA, Kikugawa-shi (JP); Takaaki KUMAGAI, Kikugawa-shi (JP); Keigo NAKAJIMA, Kikugawa-shi (JP); Koji KUSHIMA, Kikugawa-shi (JP); Shingo AGATA, Kikugawa-shi (JP)

(73) Assignee: FUJI OOZX Inc., Kikugawa-shi, Shizuoka (JP)

(21) Appl. No.: 17/922,493

(22) PCT Filed: Jul. 29, 2020
(86) PCT No.: PCT/JP2020/029158

§ 371 Date: Oct. 31, 2022

(51) Int. Cl. F01L 3/04; B21K 1/22; B24B 29/00

(52) U.S. Cl. CPC F01L 3/04; B21K 1/22; B24B 29/005; F01L 2301/00; F01L 2303/00

(57) ABSTRACT

An engine valve having a shaft portion and a head portion expanding in diameter like a head at an edge of the shaft portion, and being to open and close a port provided in a cylinder head, wherein the head portion has a head front surface on a bottom side facing a combustion chamber side, a head rear surface on a top side facing the port side, and an outer peripheral surface of the head portion formed between the head front surface and the head rear surface, and the head portion is provided a mirror-finished mirror portion, and the head portion is provided a mirror-finished mirror portion on the entire area of the head front surface exposed to the combustion chamber and the entire area of the outer peripheral surface exposed to the combustion chamber.

### TECHNICAL FIELD

The present invention relates to an engine valve and a manufacturing method therefor.

### BACKGROUND OF THE INVENTION

Conventionally, in an engine valve that constitutes a part of a combustion chamber wall surface of an engine, there is one in which a head front surface of an engine valve has been mirror-finished (Patent Literature 1). As a result, the engine valve can suppress a temperature rise of an intake air and improve a knocking resistance.

### PRIOR ART

### Patent Literatures

Patent Literature 1: JP2018-087562A

### SUMMARY OF THE INVENTION

### Problems to Be Solved by the Invention

Since the temperature rise of the intake air usually depends on the temperature of the engine valve, it is necessary to suppress the temperature of the engine valve as much as possible. However, the temperature of the engine valve is raised by roughening an outer peripheral surface of a head portion of the engine valve in order to suppress the temperature rise of the intake air during a compression stroke. This is because the heat input from the combustion gas to the engine valve has a great effect, and the temperature rise of the engine valve causes the temperature rise of the intake air. In addition, in an intake stroke, the intake air enters a combustion chamber after coming into contact with a head rear surface of an intake valve, resulting in the temperature rise of the intake air. Furthermore, in an exhaust stroke, since a heat of an exhaust gas also is input to the head rear surface of the exhaust valve, which has a wider surface area than the head front surface of an exhaust valve, it was not sufficient to suppress the temperature rise of the intake air and to suppress the temperature rise of the engine valve only by mirror-finishing to the head front surface.

The present invention has been made in view of the above problems. An object of the present invention is to provide an engine valve and a manufacturing method therefor that can suppress the temperature rise of the intake air and the temperature rise of the engine valve.

### Means for Solving the Problems

(1) According to the first aspect of the present invention, an engine valve having a shaft portion and a head portion expanding in diameter like a head at an edge of the shaft portion, and being to open and close a port provided in a cylinder head, wherein the head portion has a head front surface on a bottom side facing a combustion chamber side, a head rear surface on a top side facing the port side, and an outer peripheral surface of the head portion formed between the head front surface and the head rear surface, and the head portion is provided a mirror-finished mirror portion on the entire area of the head front surface exposed to the combustion chamber and the entire area of the outer peripheral surface.

According to the first aspect of the present invention, in the engine valve, it is possible to suppress the heat input from the head front surface and the outer peripheral surface due to the combustion gas in the engine.

(2) According to the second aspect of the present invention, in the first aspect described above, the mirror-finished mirror portion is provided on a part or the entire area of the head rear surface.

According to the second aspect of the present invention, in the engine valve, the intake valve can suppress the heating of the intake air from the head rear surface in the engine, and the exhaust valve can suppress the heat input from the head rear surface due to the exhaust gas in the engine.

(3) According to the third aspect of the present invention, in the first aspect or the second aspect described above, the engine valve is to open and close the port by axially slidably supporting the shaft portion in a valve guide, and the shaft portion has a mirror-finished mirror portion at a portion exposed from the valve guide when the engine valve is closed.

According to the third aspect of the present invention, in the engine valve, the intake valve can suppress the heating of the intake air in the engine from the shaft portion, and the exhaust valve can suppress the heat input from the shaft portion due to the exhaust gas in the engine.

(4) According to the fourth aspect of the present invention, in any one of the first to third aspects described above, the mirror portion is a coated mirror portion coated with a metal having high temperature resistance and corrosion resistance.

According to the fourth aspect of the present invention, in the engine valve, it is possible to prevent the growth of releasable oxide film, intergranular corrosion, etc., and improve the durability of the engine valve.

(5) According to a fifth aspect of the present invention, a manufacturing method of an engine valve according to any one of the first to third aspects described above, comprising: a step of forming a rod-shaped material into a semi-finished product having the same shape as a finished product by processing including at least forging; and a final step of mirror-finishing at least a portion of a surface of a semi-finished product head portion corresponding to the head portion in the semi-finished product; wherein the final step is either a brushing processing or a plastic working.

(6) According to the sixth aspect of the present invention, in the above fifth aspect described above, the final step is the brushing processing, and a part of the engine valve is mirror-finished by any one of a cutting, a polishing, the brushing processing, or the plastic working in a pre-step of the final step.

(7) According to the seventh aspect of the present invention, in the above fifth aspect described above, the final step is the plastic working, and a part of the engine valve is mirror-finished by any one of a cutting, a polishing, the brushing processing, or the plastic working in a pre-step of the final step.

### Advantages of the Invention

According to the present invention, the temperature rise of the intake air in the engine can be suppressed, and the temperature rise of the engine valve can be suppressed.

### BRIEF DESCRIPTION OF THE DRAWINGS

FIG. 1 is a schematic view showing a part of an engine provided with engine valves in accordance with an embodiment of the present invention.

FIG. 2 is a side view showing a part of an engine valve in accordance with an embodiment of the present invention.

FIG. 3 is a bottom view showing a head front surface of an engine valve in accordance with an embodiment of the present invention.

FIG. 4 is a side view showing a part of an engine valve when the port is open in a modified example 1-2 of a mirror portion.

FIG. 5 is a side view showing a part of an engine valve in a modified example 1-3 of a mirror portion.

FIG. 6 is a side view showing a part of an engine valve in a modified example 1-4 of a mirror portion.

FIG. 7 is a flow chart showing a process from molding of an engine valve to mirror-finishing in accordance with an embodiment of the present invention.

FIG. 8 is a flow chart showing the process up to mirror-finishing in the manufacturing method of an engine valve in accordance with an embodiment of the present invention.

FIG. 9 is a schematic view of an engine valve and a burnishing device for explaining burnishing processing in the manufacturing method of an engine valve in accordance with an embodiment of the present invention.

FIG. 10 is a schematic view for explaining brushing processing in the manufacturing method of an engine valve in accordance with an embodiment of the present invention.

FIG. 11 is a view sequentially showing the process up to mirror-finishing in the conventional manufacturing method of an engine valve.

### EMBODIMENTS OF THE INVENTION

### Present Embodiment

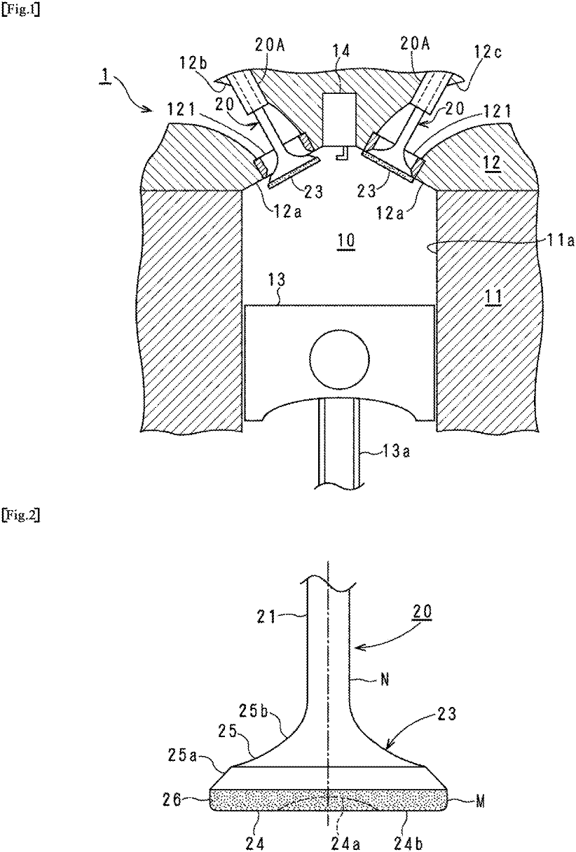

Hereinafter, the present invention will be described in detail through one embodiment of the present invention with reference to FIGS. 1 to 3. However, the following embodiments are examples and do not limit the inventions according to the claims.

### Engine 1

An engine 1 shown in FIG. 1 is applied to fossil fuel engines such as vehicles and ships. The engine 1 comprises a cylinder block 11, a cylinder head 12, a piston 13, an ignition plug 14, engine valves 20, 20, and the like.

The cylinder block 11 has a cylindrical cylinder 11a that forms a combustion chamber 10. The piston 13 is a substantially columnar shape and is connected to a crankshaft (not shown) via a rod-shaped connecting rod 13a and can reciprocate by sliding up and down inside the cylinder 11a

The cylinder head 12 is arranged above the cylinder block 11 and has a combustion chamber ceiling portion 12a covering an upper surface of the cylinder 11a. The cylinder head 12 also has an intake port 12b and an exhaust port 12c.

Engine valves 20, 20 are provided inside the intake port 12b and the exhaust port 12c, respectively. Annular valve seats 121, 121 are provided at the boundary between the intake port 12b and the combustion chamber 10 and at the boundary between the exhaust port 12c and the combustion chamber 10 respectively.

In the engine valve 20, a shaft portion 21, which will be described later, is axially slidably supported by a cylindrical valve guide 20A provided in the cylinder head 12. The engine valve 20 on a side of the intake port 12b can open and close the intake port 12b by being seated on or off the valve seat 121 (valve closing or valve opening). The engine valve 20 on a side of the exhaust port 12c can open and close the exhaust port 12c by being seated on or off the valve seat 121 (valve closing or valve opening).

The ignition plug 14 is attached between the intake port 12b and the exhaust port 12c so that an ignition portion at an edge of the ignition plug 14 protrudes into the combustion chamber 10 from the combustion chamber ceiling portion 12a.

As shown in FIG. 1, in the engine 1, the combustion chamber 10 is surrounded by the cylinder 11a, the combustion chamber ceiling portion 12a of the cylinder head 12, an upper surface of the piston 13, and a head portion 23 described later of the engine valve 20. A mixed gas (intake gas) mixed with fuel is supplied from the intake port 12b opened by opening the engine valve 20 on the side of the intake port 12b and is ignited by the ignition plug 14 and is burned. This combustion pushes the piston 13 downward. The exhaust gas generated by combustion is exhausted out of the combustion chamber 10 through the exhaust port 12c opened by opening the engine valve 20 on the side of the exhaust port 12c.

### Engine Valve 20

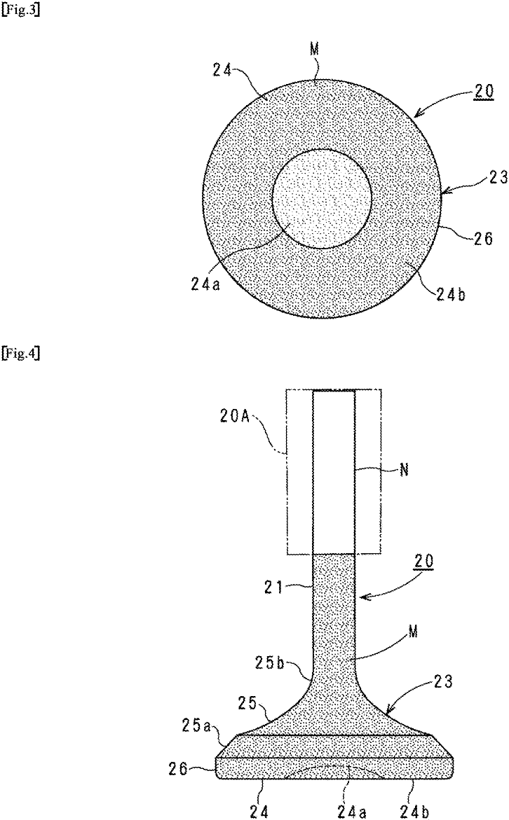

As shown in FIG. 2, the engine valve 20 comprises a shaft portion 21 formed in a round bar shape, and ahead portion 23 formed on one edge of the shaft portion 21 (lower edge in FIG. 2) so as to expand concentrically and in a head shape. In addition, the engine valve 20 is made of, for example, special steel with high heat resistance and is formed by forging. Although the engine valve 20 of the present embodiment is solid, it may be hollow to enclose a coolant such as metallic sodium.

As shown in FIG. 3, a head front surface 24 on a lower surface of the head portion 23 has a recessed portion 24a in the center and an annular portion 24b being annular in bottom view around the recessed portion 24a. Further, the head front surface 24 may be flat without providing the recessed portion 24a and the annular portion 24b.

A head rear surface 25 on an upper surface of the head portion 23 has a face surface 25a on the side of the head front surface 24 and a neck portion 25b on the side of the shaft portion 21. The face surface 25a extends straight in an upward direction and in a centripetal direction from an upper portion of an outer peripheral surface 26. The neck portion 25b is provided continuously from an upper edge of the face surface 25a and extends toward the shaft portion 21 while curving in an upward direction and in a centripetal direction. The face surface 25a can come into contact with a lower edge of the valve seat 121 (refer to FIG. 1). The outer peripheral surface 26 formed by the thickness of the head portion 23 is provided between the head front surface 24 and the head rear surface 25.

As shown in FIG. 1, the engine valve 20 is mounted so that at least the head front surface 24 and the outer peripheral surface 26 of the head portion 23 are exposed in the combustion chamber 10 during an intake stroke and an exhaust stroke of the engine 1.

### Mirror Portion M

In the engine valve 20 of the present embodiment, a portion that is likely to be exposed to high temperatures is mirror-finished. Specifically, as shown in FIGS. 2 and 3, a mirror-finished mirror portion M is provided over the entire head front surface 24 of the engine valve 20. As a result, the engine valve 20 can suppress the temperature rise of the intake gas and can suppress the heat input from the head front surface 24 due to the exhaust gas.

In addition, along with the head front surface 24, the mirror-finished mirror portion M is provided over the entire outer peripheral surface 26. As a result, the engine valve 20 can suppress heat input from the head front surface 24 and the outer peripheral surface 26 exposed in the combustion chamber 10. By suppressing the heat input from the portion that is likely to be exposed to high temperatures in this way, an actual temperature rise (high temperature) of the engine valve 20 is suppressed. This allows the engine valve 20 to withstand use in high temperature environments. In addition, a non-mirror-finished area excluding the head front surface 24 and the outer peripheral surface 26 is referred to as a non-mirror portion N.

In addition to the mirror-finishing each component of the engine valve 20 described above, some surface or whole surface within the combustion chamber 10 may be mirror-finished.

The mirror portion M of the present embodiment has a constant surface roughness (for example, Ra (arithmetic mean roughness) is 0.3). In addition, the mirror-finishing of the mirror portion M may be performed by removal processing such as cutting or polishing and may be performed by surface treatment by plating process (hot dip plating, vacuum plating, etc.) using a metal having high temperature resistance and corrosion resistance (a portion mirror-finished by the plating process is referred to as a coated mirror portion). For example, Cr plating, Ni-Cr plating, or the like is adopted as the plating process. When the plating process is performed, the engine valve 20 may be subjected to base preparation by polishing or the like or may be performed without base preparation. By mirror-finishing the engine valve 20 by plating process in this way, it is possible to prevent the growth of releasable oxide film, intergranular corrosion, etc., and improve the durability of the engine valve 20.

### Modified Example of Mirror Portion M

The mirror portion M can be modified and changed as follows. Further, it is possible to appropriately combine the respective configuration (portion), treatment, condition, etc. in the embodiment of the present invention described above and the modified examples described below.

### Modified Example 1-1

Along with the head front surface 24 and the outer peripheral surface 26 which are mirror-finished in the above embodiment, the head rear surface 25 may be mirror-finished. Specifically, a mirror-finished mirror portion M may be provided on a part or the entire area of either or both the face surface 25a and the neck portion 25b on the head rear surface 25. As a result, the engine valve 20 suppresses the temperature rise of the intake gas and suppresses the heat input from the head rear surface 25 by the exhaust gas, thereby the engine valve 20 can suppress an actual temperature rise (high temperature).

### Modified Example 1-2

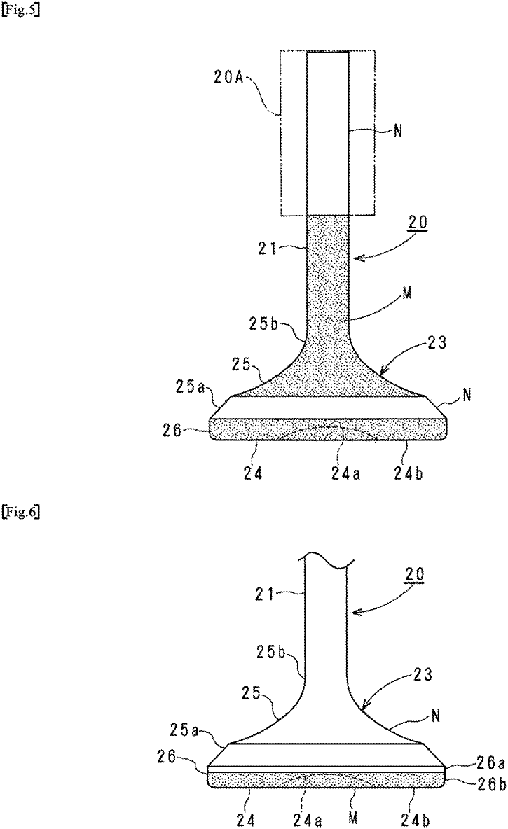

On the shaft portion 21 of the engine valve 20, a mirror-finished mirror portion M may be provided in a part or the entire area exposed from the valve guide 20A of the engine valve 20 (FIG. 4 is an example in which the exposed entire area is mirror-finished). As a result, the engine valve 20 suppresses the temperature rise of the intake gas and suppresses the heat input from the shaft portion 21 by the exhaust gas, thereby the engine valve 20 can suppress an actual temperature rise (high temperature). In addition, the mirror-finished mirror portion M may be provided over the entire shaft portion 21.

As described above, in the engine valve 20, the effect of suppressing the high temperature of the engine valve 20 can be enhanced as the area of the mirror portion M is increased.

### Modified Example 1-3

As shown in FIG. 5, as an example of providing a mirror portion M on a portion of the engine valve 20 exposed from the valve guide 20A, in the areas of the engine valve 20 exposed from the valve guide 20A, the mirror portion M may be provided over the entire area except for the face surface 25a that is a portion that contacts the cylinder head 12 (valve seat 121). That is, the non-mirror portion N may be provided only on the face surface 25a within the area exposed from the valve guide 20A of the mirror-finished engine valve 20.

### Modified Example 1-4

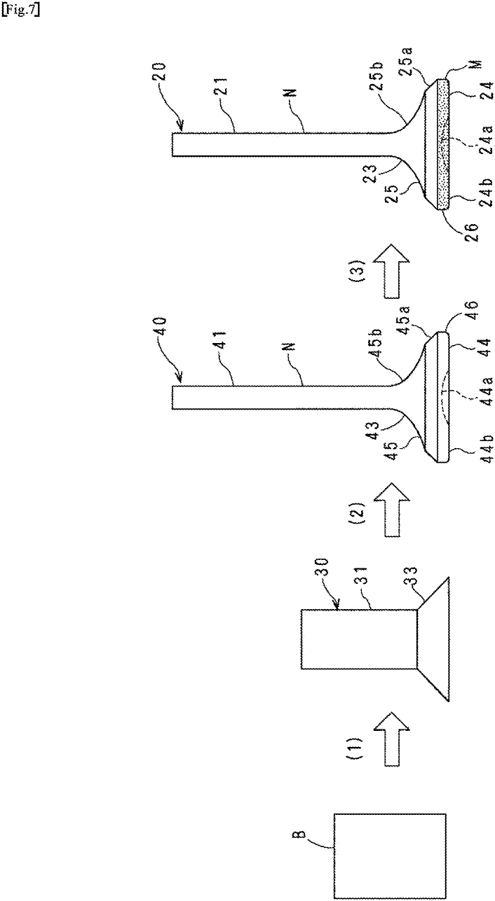

As shown in FIG. 6, along with the head front surface 24, only a portion of the outer peripheral surface 26 of the head portion 23 may be mirror-finished. For example, in an upper outer peripheral surface 26a and a lower outer peripheral surface 26b that constitute the outer peripheral surface 26, only the lower outer peripheral surface 26b may be provided with the mirror-finished mirror portion M. Here, the upper outer peripheral surface 26a is on the side of the head rear surface 25 and is chamfered and has an R shape when viewed in vertical cross section, the lower outer peripheral surface 26b is on the side of the head front surface 24 and extends upward from the head front surface 24.

### Modified Example 2

The surface roughness (degree of mirror finish) may be appropriately changed for each part of the engine valve 20. For example, so that the head front surface 24 has an Ra of 0.3, the outer peripheral surface 26 and the head rear surface 25 have an Ra of 0.4, and the shaft portion 21 has an Ra of 0.5, the roughness of the surface may be smoothed step by step from the shaft portion 21 toward the head front surface 24, the head front surface 24 (which may include the outer peripheral surface 26) may be the smoothest, and the other portions may be rougher than the head front surface 24.

A mirror portion M formed on a part or the entire area of the shaft portion 21, the head rear surface 25, or the outer peripheral surface 26 of the engine valve 20 has an annular shape.

### Manufacturing Process of Engine Valve 20

Next, a manufacturing process of the engine valve 20 will be described. The manufacturing process consists of a molding step and a mirror step.

As shown in FIG. 7, (1) in a first molding step, a solid round bar B having a predetermined shape (for example, columnar shape) is hot forged to form a first semi-finished product 30. In the first semi-finished product 30, a shaft portion 31 corresponding to the shaft portion 21 of the engine valve 20, which is a finished product is formed, and a head portion 33 corresponding to the head portion 23 of the engine valve 20, which is a finished product is formed. (2) In the second molding step, the first semi-finished product 30 is sequentially subjected to cold forging and drawing to form a second semi-finished product 40.

The second semi-finished product 40 has the same shape (structure) as the engine valve 20, which is a finished product, and the only difference is whether the head portion 23 is mirror-finished. That is, the second semi-finished product 40 is the non-mirror portion N over the entire area, and the engine valve 20 is provided the mirror portion M on a portion of the head portion. For convenience of explanation, each structure corresponding to each structure of the engine valve 20 in the second semi-finished product 40 will be described as a shaft portion 41, a head portion 43, a head front surface 44, a recessed portion 44a, an annular portion 44b, a head rear surface 45, a face surface 45a, a neck portion 45b, and an outer peripheral surface 46.

As shown in FIG. 7, (3) in the mirror step, as will be described later, the head front surface 44 and the outer peripheral surface 46 of the head portion (semi-finished product head portion) 43 of the second semi-finished product 40 are mirror-finished (mirror processing).

### Conventional Mirror Processing

Here, in the conventional mirror processing of engine valves, it is necessary to gradually reduce the roughness of the surface to smooth it out. Therefore, for example, as shown in FIG. 11, polishing and the like are performed in four steps of rough processing, medium processing, finish processing, and super-finish processing. For example, the rough processing and the medium processing may be performed by the cutting or the polishing, while the finish processing and the super-finish processing may be performed by the polishing. In addition, in the finish processing, a flat portion is performed by a mechanical polishing, and in the super-finish processing, a curved surface portion, a recessed portion, etc. are performed by a hand polishing.

Specifically, in the cutting, for example, the surface is smoothed by cutting a machining allowance (for example, about 0.1 mm) of the engine valve using an NC lathe. In addition, in the polishing, an abrasive cloth and paper and a special abrasive film are used, and a grain size becomes finer as the step proceeds. Specifically, the grain size can be used, for example, 60 (#60) in the rough processing, 400 (#400) in the medium processing, 1000 (#1000) in the finish processing, and 1500 (#1500) in the super-finish processing.

In this way, in conventional mirror processing, the engine valves must be polished step by step in four steps. In addition, it was necessary to change a polishing method (for example, change from the mechanical polishing to the manual polishing) depending on a portion to be processed. As a result, the number of work steps increases, resulting in increasing of cost and time.

### Mirror Processing of Present Embodiment

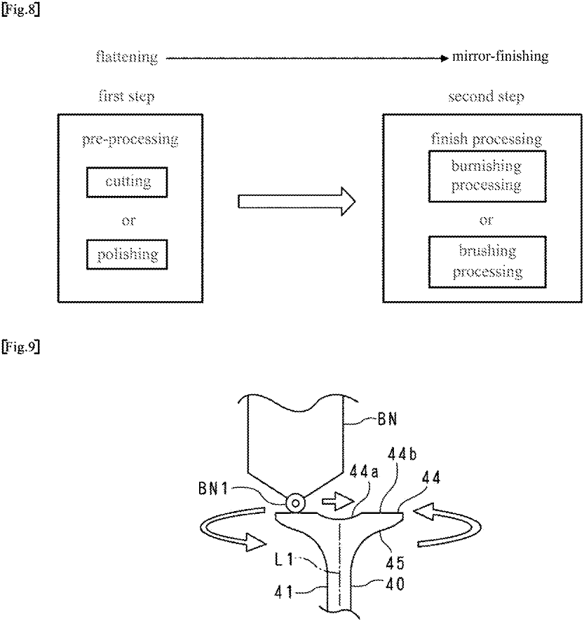

As shown in FIG. 8, the mirror processing of the engine valve 20 of the present embodiment is composed of two steps: a pre-processing in a first step (pre-step) and a finish processing in a second step (final step). The cutting or the polishing is performed in the first step, and the burnishing processing (plastic working) or the brushing processing is performed in the second step. These can be changed as appropriate according to the required surface roughness. As described above, in the present embodiment, it is possible to omit the steps in the above-described conventional mirror processing of the engine valve and to reduce the number of man-hours.

In the case of the mirror processing of the present embodiment, the grain size of the abrasive cloth and paper or the like employed in the first step is, for example, 200 (#200). This is a finer grain size than the rough processing in conventional processing methods. Thereby, the polishing load in the finish processing can be reduced.

### Burnishing Processing

The burnishing processing uses a burnishing device BN. The burnishing device BN has a high-strength burnishing edge BN1 such as a small (for example, about 1 mm to 2 mm) roller-shaped diamond chip. A burnishing device BN is used to plastically deform the head front surface 44 and the like of the second semi-finished product 40 to achieve the mirror-finishing.

Specifically, the burnishing device BN is movable to vertical direction and horizontal direction by a driving device (not shown). As shown in FIG. 9, the second semi-finished product 40 is rotated at high speed around the axis L1 of the shaft portion 41 by a rotating device (not shown) at a lower region of the burnishing device BN. The burnishing edge BN1 is pressed against one edge of the head front surface 44 of the second semi-finished product 40 with a predetermined force and is moved for rolling compaction toward the other edge at a predetermined speed, that is, is moved while crushing the irregularities on a surface. Thereby, the head front surface 44 can be uniformly performed the rolling compaction. At that time, the burnishing edge BN1 moves for the rolling compaction not only to the annular portion 44b of the head front surface 44, but also to the recessed portion 44a as described later, with the same force as a pressing force against the annular portion 44b. Therefore, the entire area of the head front surface 44 can be mirror-finished.

In addition, regarding mirror-finishing of the outer peripheral surface 46 of the second semi-finished product 40, the burnishing edge BN1 is pressed against the outer peripheral surface 46 with a predetermined force in the condition that the second semi-finished product 40 is rotated around the axis L1 at high speed. As a result, the outer peripheral surface 26 can be uniformly performed the rolling compaction and can be mirror-finished. At this time, the entire area of the outer peripheral surface 46 can be mirror-finished. However, by performing the rolling compaction only the upper outer peripheral surface 26a or the lower outer peripheral surface 26b as the above modified example 1-3, a portion of the outer peripheral surface 46 may be mirror-finished.

The burnishing device BN can adjust the position of the burnishing edge BN1 in the pressing direction based on the pressing force of the burnishing edge BN1 against a workpiece detected by a pressure sensor (not shown) provided near the burnishing edge BN1. As a result, the workpiece can be performed the rolling compaction with a constant force (pressing force), so that the recessed portion 44a of the curved head front surface 44 and the head rear surface 45 can also be performed the burnishing processing.

For example, when the head rear surface 45 is performed the burnishing processing, in the condition that the second semi-finished product 40 is rotated around the axis L1 at high speed, the burnishing device BN presses the burnishing edge BN1 against an edge on the side of the outer peripheral surface 46 of the face surface 45a of the second semi-finished product 40 with a predetermined force. Then, while adjusting a position of a pressing direction, the burnishing edge BN1 is moved toward the neck portion 45b while performing the rolling compaction at a predetermined speed. As a result, the head rear surface 45 can be uniformly performed the rolling compaction. In addition, when the shaft portion 41 is also desired to be performed the burnishing processing, the burnishing edge BN1 is continuously moved toward an upper edge of the shaft portion 41 while performing the rolling compaction at a predetermined speed.

As a result of the burnishing processing, the roughness of the mirror portion M can be set to, for example, an average Ra of around 0.1.

### Brushing Processing

In the brushing processing, the head front surface 44 and the like of the second semi-finished product 40 are mirror-finished by brushing with a brush device BR having a brush body BR1.

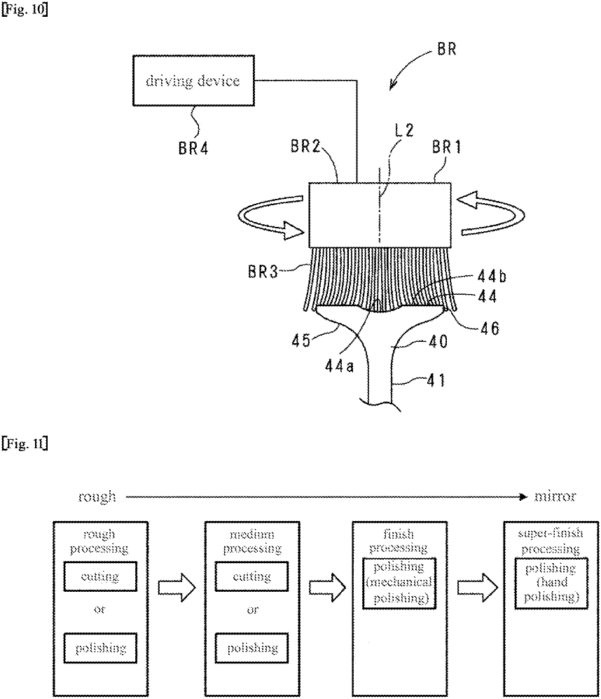

As shown in FIG. 10, a brush body BR1 is composed of a cylindrical brush base BR2 and a pilus material BR3 planted on a lower surface of the brush base BR2. The brush body BR1 is rotatable around an axis L2 of the brush base BR2 by a driving device BR4. For example, #8000 is used for the pilus material BR3 for finishing.

As shown in FIG. 10, the second semi-finished product 40 is fixed upward by a fixture (not shown) so that the head front surface 44 faces tips of the pilus material BR3 of the brush body BR1. The brush body BR1 is rotated in the condition that the tips of the pilus material BR3 at a center of the brush body BR1 are in contact with at least a bottom of the recessed portion 44a at a center of the head front surface 44 (the pilus material BR3 around the recessed portion 44a is in a slightly bent state). Thus, the second semi-finished product 40 is polished by this brushing. Furthermore, at this time, the outer peripheral surface 46 of the head portion 43 of the second semi-finished product 40 is also polished since the outer peripheral surface 46 contacts the pilus material BR3 on the peripheral edge of the brush body BR1.

As described above, in the brushing processing, the pilus material BR3 can flexibly come into contact with the shape of the workpiece. Therefore, it is possible to polish not only a flat portion (for example, the annular portion 44b of the head front surface 44) of the second semi-finished product 40 but also a curved surface portion and the recessed portion (for example, the shaft portion 41, the recessed portion 44a, the head rear surface 45, the face surface 45a, the neck portion 45b, the outer peripheral surface 46).

As a result of the brushing processing, the roughness of the mirror portion M can be set to, for example, an average Ra of around 0.05.

The brushing processing may be performed while continuously supplying the second semi-finished product 40 with a working liquid in which abrasive grains are mixed with water. In this case, the particle size is gradually reduced (#1000 to #10000).

### Modified Example of Mirror Processing

As for the mirror processing, it is possible to apply the following modifications and changes. In addition, it is possible to appropriately combine the respective structure (portion), treatment, condition, etc. in the embodiment of the present invention described above and modified examples described below.

### Modified Example 1

When the surface of the second semi-finished product 40 is subjected to nitriding treatment, the nitriding treatment may be performed first, and the mirror finishing may be performed after the first step and the second step of the above embodiment. In addition, the nitriding treatment may be performed after the first step, and then the second step may be performed.

### Modified Example 2

In the present embodiment, although the cutting or the polishing is performed in the first step, the brushing processing or the burnishing processing may be performed.

### Modified Example 3

In the present embodiment, although the brushing processing or the burnishing processing is performed in the second step, the brushing processing may be performed after the burnishing processing, or the burnishing processing may be performed after the brushing processing.

REFERENCE SIGNS LIST

| BN | burnishing device | BN1 | burnishing edge |
|---|---|---|---|
| BR | brush device | BR1 | brush body |
| BR2 | brush base | BR3 | pilus material |
| BR4 | driving device | | |
| M | mirror portion | | |
| 1 | engine | 10 | combustion chamber |
| 11 | cylinder block | 11 a | cylinder |
| 12 | cylinder head | 12 a | combustion chamber ceiling portion |
| 12 b | intake port | 12 c | exhaust port |
| 13 | piston | 14 | ignition plug |
| 20 | engine valve | 21 | shaft portion |
| 23 | head portion | 24 | head front surface |
| 24 a | recessed portion | 24 b | annular portion |
| 25 | head rear surface | 25 a | face surface |
| 25 b | neck portion | 26 | outer peripheral surface |
| 30 | first semi-finished product | 31 | shaft portion |
| 33 | head portion | | |
| 40 | second semi-finished product | 41 | shaft portion |
| 43 | head portion | 44 | head front surface |
| 44 a | recessed portion | 44 b | annular portion |
| 45 | head rear surface | 45 a | face surface |
| 45 b | neck portion | 46 | outer peripheral surface |

1-7. (canceled)

8. An engine valve having a shaft portion and a head portion expanding in diameter like a head at an edge of the shaft portion, and being to open and close a port provided in a cylinder head,
wherein the head portion has a head front surface on a bottom side facing a combustion chamber side, a head rear surface on a top side facing the port side, and an outer peripheral surface of the head portion formed between the head front surface and the head rear surface, and the head portion is provided a mirror-finished mirror portion on the entire area of the head front surface exposed to the combustion chamber and is provided a mirror-finished mirror portion only on a lower portion on the bottom side in the outer peripheral surface continuous from the head front surface.

9. The engine valve according to claim 8, wherein the mirror-finished mirror portion is provided on a part or the entire area of the head rear surface.

10. The engine valve according to claim 8, wherein the engine valve is to open and close the port by axially slidably supporting the shaft portion in a valve guide, and the shaft portion has a mirror-finished mirror portion at a portion exposed from the valve guide when the engine valve is closed.

11. The engine valve according to claim 8, wherein the mirror portion is a coated mirror portion coated with a metal having high temperature resistance and corrosion resistance.

12. A manufacturing method of an engine valve according to claim 8, comprising:
a step of forming a rod-shaped material into a semi-finished product having the same shape as a finished product by processing including at least forging; and
a final step of integrally mirror-finishing a head front surface and an outer peripheral surface continuous from the head front surface in a semi-finished product head portion corresponding to the head portion of the finished product,
wherein the final step is either a brushing processing or a plastic working.

13. The manufacturing method of the engine valve according to claim 12,
wherein the final step is the brushing processing, and a part of the engine valve is mirror-finished by any one of a cutting, a polishing, the brushing processing, or the plastic working in a pre-step of the final step.

14. The manufacturing method of the engine valve according to claim 12,
wherein the final step is the plastic working, and a part of the engine valve is mirror-finished by any one of a cutting, a polishing, the brushing processing, or the plastic working in a pre-step of the final step.
